(19) United States
(12) Patent Application Publication
(10) Pub. No.: US 2025/0249903 A1
(43) Pub. Date: Aug. 7, 2025

(54) VEHICLE CONTROLLER, METHOD, AND COMPUTER PROGRAM FOR VEHICLE CONTROL

(71) Applicant: TOYOTA JIDOSHA KABUSHIKI KAISHA, Toyota-shi Aichi-ken (JP)

(72) Inventor: Kenta Kumazaki, Bunkyo-ku Tokyo-to (JP)

(73) Assignee: TOYOTA JIDOSHA KABUSHIKI KAISHA, Toyota-shi Aichi-ken (JP)

(21) Appl. No.: 19/037,367

(22) Filed: Jan. 27, 2025

(30) Foreign Application Priority Data
Feb. 1, 2024 (JP) 2024-014186

(51) Int. Cl. B60W 30/16; B60W 50/14

(52) U.S. Cl. CPC B60W 30/162; B60W 50/14; B60W 2520/105; B60W 2554/406; B60W 2554/802; B60W 2720/106

(57) ABSTRACT

A vehicle controller includes a processor configured to set an upper limit of a rate of change in acceleration for a case where drive assist mode in which travel of a host vehicle is controlled depending on a distance between a vehicle ahead and the host vehicle is applied to be less than the upper limit for a case where a driver of the host vehicle manually drives, when travel of the host vehicle is controlled in high response mode in which responsiveness to acceleration is higher than in normal travel mode, and control travel of the host vehicle so that the rate of change in acceleration is less than or equal to the set upper limit.

### CROSS-REFERENCE TO RELATED APPLICATIONS

This application claims priority to Japanese Patent Application No. 2024-014186 filed Feb. 1, 2024, the entire contents of which are herein incorporated by reference.

### FIELD

The present disclosure relates to a vehicle controller, a method, and a computer program for vehicle control.

### BACKGROUND

A vehicle allows a driver to select a travel mode from among multiple travel modes that differ in responsiveness to acceleration/deceleration of the vehicle. For such a vehicle, a technique to select which travel mode related to drive assist control is to be applied to the vehicle has been proposed (see Japanese Unexamined Patent Publication No. 2023-28560).

### SUMMARY

As a travel mode of a host vehicle, one in which responsiveness to acceleration is higher than in normal travel mode (hereafter “high response mode”), such as sport mode, is set in some cases, together with drive assist mode in which travel of the host vehicle is controlled depending on the distance between a vehicle ahead and the host vehicle. In such cases, the vehicle may repeat sudden acceleration and deceleration in traffic congestion, making a driver uneasy.

It is an object of the present disclosure to provide a vehicle controller that can control travel of a vehicle so as not to make a driver uneasy even when drive assist mode is applied and high response mode is set.

A vehicle controller according to an embodiment includes a processor configured to: set an upper limit of a rate of change in acceleration for a case where drive assist mode in which travel of a host vehicle is controlled depending on a distance between a vehicle ahead and the host vehicle is applied to be less than the upper limit for a case where a driver of the host vehicle manually drives, when travel of the host vehicle is controlled in high response mode in which responsiveness to acceleration is higher than in normal travel mode, and control travel of the host vehicle so that the rate of change in acceleration is less than or equal to the set upper limit.

In an embodiment, the processor is further configured to stop applying the high response mode while the drive assist mode is applied.

In an embodiment, the processor is further configured to detect traffic congestion around the host vehicle. When the traffic congestion is detected, the processor makes the upper limit of the rate of change in acceleration less than when the traffic congestion is not detected.

In an embodiment, the processor decreases the upper limit of the rate of change in acceleration as the speed of the host vehicle decreases.

A vehicle controller according to another embodiment includes a processor configured to: notify a driver of a host vehicle, via a notification device provided in the host vehicle, that high response mode in which responsiveness to acceleration is higher than in normal travel mode is set, when drive assist mode in which travel of the host vehicle is controlled depending on a distance between a vehicle ahead and the host vehicle is additionally applied while travel of the host vehicle is controlled in the high response mode.

In an embodiment, the processor is further configured to detect traffic congestion around the host vehicle. The processor gives notification that the high response mode is set, before the host vehicle starts decelerating after the traffic congestion is detected.

A method for vehicle control according to still another embodiment includes setting an upper limit of a rate of change in acceleration for a case where drive assist mode in which travel of a host vehicle is controlled depending on a distance between a vehicle ahead and the host vehicle is applied to be less than the upper limit for a case where a driver of the host vehicle manually drives, when travel of the host vehicle is controlled in high response mode in which responsiveness to acceleration is higher than in normal travel mode; and controlling travel of the host vehicle so that the rate of change in acceleration is less than or equal to the set upper limit.

A non-transitory recording medium that stores a computer program for vehicle control according to yet another embodiment includes instructions causing a processor mounted on a host vehicle to execute a process including: setting an upper limit of a rate of change in acceleration for a case where drive assist mode in which travel of the host vehicle is controlled depending on a distance between a vehicle ahead and the host vehicle is applied to be less than the upper limit for a case where a driver of the host vehicle manually drives, when travel of the host vehicle is controlled in high response mode in which responsiveness to acceleration is higher than in normal travel mode; and controlling travel of the host vehicle so that the rate of change in acceleration is less than or equal to the set upper limit.

The vehicle controller according to the present disclosure has an effect of being able to control travel of a vehicle so as not to make a driver uneasy even when drive assist mode is applied and high response mode is set.

### BRIEF DESCRIPTION OF DRAWINGS

FIG. 1 schematically illustrates the configuration of a vehicle equipped with the vehicle controller.

FIG. 2 is a functional block diagram of a processor of an electronic control unit, related to a vehicle control process according to a first embodiment.

FIG. 3 schematically illustrates acceleration/deceleration control in drive assist mode according to the first embodiment for the case where high response mode is set.

FIG. 4 is an operation flowchart of the vehicle control process according to the first embodiment.

FIG. 5 is a functional block diagram of the processor of the electronic control unit, related to a vehicle control process according to a second embodiment.

FIG. 6 is an operation flowchart of the vehicle control process according to the second embodiment.

### DESCRIPTION OF EMBODIMENTS

A vehicle controller, a method for vehicle control executed by the vehicle controller, and a computer program for vehicle control will now be described with reference to the attached drawings. The vehicle controller can select and set one of multiple travel modes that differ in responsiveness to acceleration. In addition, the vehicle controller can assist a driver of a host vehicle in driving, by applying drive assist mode in which travel of the host vehicle is controlled depending on the distance between the host vehicle and a vehicle traveling ahead of the host vehicle. In particular, the vehicle controller is set to a travel mode in which responsiveness to acceleration is higher than in normal travel mode (hereafter “high response mode”), and sets the upper limit of the amount of change in acceleration per unit time (hereafter the “rate of change in acceleration”) for the case where drive assist mode is applied below the upper limit for the case where the driver manually drives. Alternatively, the vehicle controller notifies the driver that high response mode is applied, when drive assist mode is additionally applied while high response mode is set.

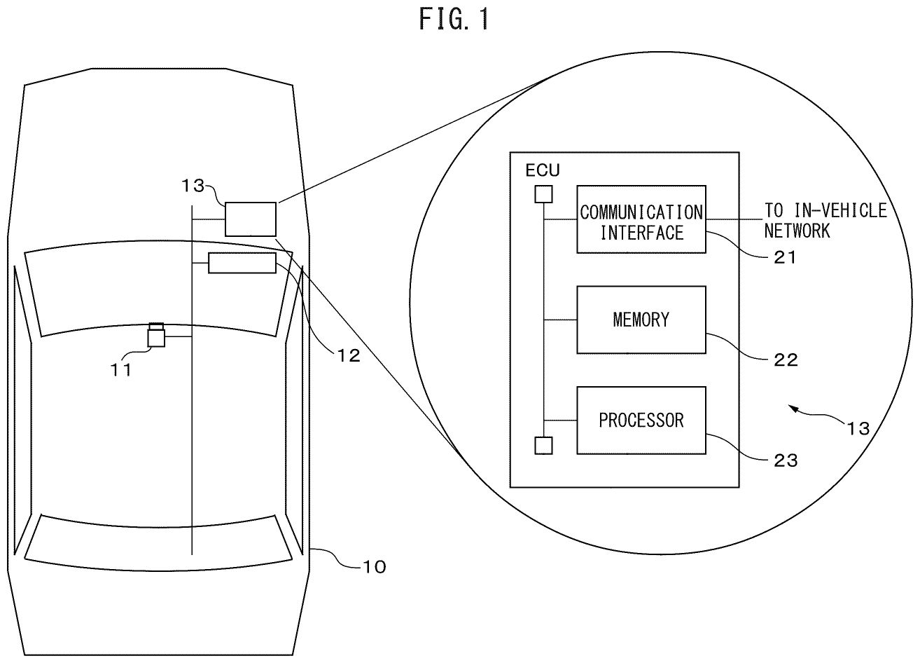

FIG. 1 schematically illustrates the configuration of a vehicle equipped with the vehicle controller. The vehicle 10, which is an example of the host vehicle, includes a vehicle exterior sensor 11, a notification device 12, and an electronic control unit (ECU) 13.

The vehicle 10 has multiple selectable travel modes that differ in responsiveness to acceleration for the case where the accelerator position is changed. The multiple travel modes include normal travel mode and high response mode in which responsiveness to acceleration is higher than in normal travel mode. The multiple travel modes may include multiple high response modes that differ in responsiveness to acceleration. Such high response mode is referred to as, for example, sport mode or power mode. The high response mode in the following description may be any of the high response modes. The multiple travel modes may further include one or more travel modes in which responsiveness to acceleration is lower than in normal travel mode but fuel efficiency is higher (hereafter “fuel-efficient mode”).

The travel modes may differ in responsiveness to deceleration as well as responsiveness to acceleration. Thus high response mode may be set so that responsiveness to deceleration as well as responsiveness to acceleration is higher than in normal travel mode. Similarly, fuel-efficient mode may be set so that responsiveness to deceleration as well as responsiveness to acceleration is lower than in normal travel mode. In the following description, assume that the travel modes differ in both responsiveness to acceleration and responsiveness to deceleration. Responsiveness to acceleration and responsiveness to deceleration will be collectively referred to as “responsiveness to acceleration/deceleration.” When travel modes are identical in responsiveness to deceleration and differ in responsiveness to acceleration, it should be understood that the following description related to responsiveness to acceleration/deceleration and the rate of change in acceleration/deceleration is a description related to responsiveness to acceleration and the rate of change in acceleration. In the following, control related to acceleration or deceleration depending on a travel mode applied to the vehicle 10 will be referred to simply as “acceleration/deceleration control.”

The vehicle exterior sensor 11 is a sensor that generates an exterior sensor signal representing the surroundings of the vehicle 10, e.g., a camera configured to be capable of taking pictures of an area around the vehicle 10 or a range sensor, such as LiDAR or radar. The vehicle 10 may be provided with multiple vehicle exterior sensors 11 that differ in detectable range or type. Every time an exterior sensor signal is generated, the vehicle exterior sensor 11 outputs the generated exterior sensor signal to the ECU 13.

The notification device 12, which is an example of a notification unit, is provided in the interior of the vehicle 10. The notification device 12 includes, for example, at least one of a speaker, a light source, a vibrator, or a display. When a notification signal indicating predetermined notification to the driver is received from the ECU 13, the notification device 12 gives the notification to the driver by a voice from the speaker, the light of the light source, vibrations of the vibrator, or display of a message on the display. When the notification device 12 includes two or more types of devices, the notification may be given to the driver via each of the two or more types of devices.

The ECU 13, which is an example of the vehicle controller, executes acceleration/deceleration control of the vehicle 10 depending on a set travel mode among the multiple travel modes. When drive assist mode is applied, the ECU 13 further executes drive assist control for the driver of the vehicle 10.

The ECU 13 includes a communication interface 21, a memory 22, and a processor 23. The communication interface 21, the memory 22, and the processor 23 may be configured as separate circuits or a single integrated circuit.

The communication interface 21 includes an interface circuit for connecting the ECU 13 to another device. The communication interface 21 passes a signal from the vehicle exterior sensor 11 to the processor 23. In addition, the communication interface 21 outputs a control signal of a power train (not illustrated) received from the processor 23 to the power train. In addition, the communication interface 21 outputs a notification signal received from the processor 23 to the notification device 12.

The memory 22, which is an example of a storage unit, includes volatile and nonvolatile semiconductor memories. The memory 22 stores various types of data used in or generated during a vehicle control process executed by the processor 23.

The processor 23 includes one or more central processing units (CPUs) and a peripheral circuit thereof. The processor 23 may further include another operating circuit, such as a logic-arithmetic unit, an arithmetic unit, or a graphics processing unit. The processor 23 executes the vehicle control process on the vehicle 10.

### First Embodiment

The following describes a vehicle control process according to a first embodiment executed by the processor 23. In this embodiment, when high response mode is set as a travel mode, the processor 23 sets the upper limit of the rate of change in acceleration/deceleration for the case where drive assist mode is applied below the upper limit for the case where the driver manually drives.

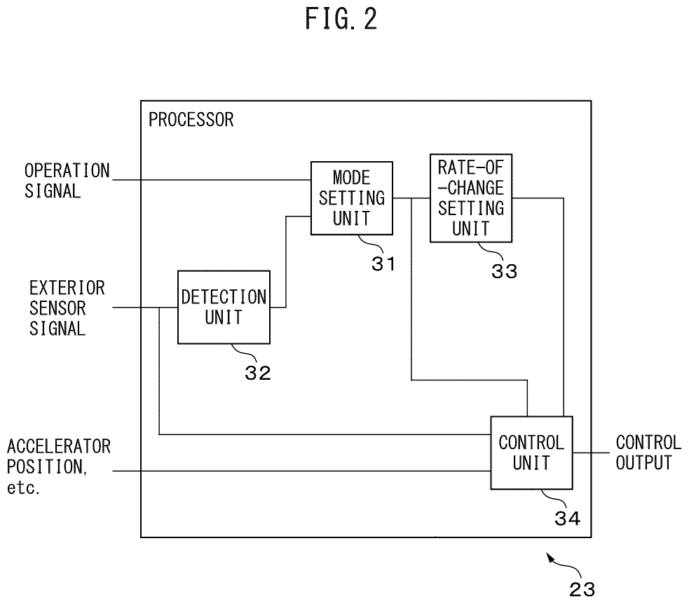

FIG. 2 is a functional block diagram of the processor 23, related to a vehicle control process according to the first embodiment. The processor 23 includes a mode setting unit 31, a detection unit 32, a rate-of-change setting unit 33, and a control unit 34. These units included in the processor 23 are, for example, functional modules implemented by a computer program executed by the processor 23, or may be dedicated operating circuits provided in the processor 23.

The mode setting unit 31 sets a travel mode to be applied to acceleration/deceleration control of the vehicle 10 from among the multiple travel modes that differ in responsiveness to acceleration/deceleration.

The mode setting unit 31 sets a travel mode specified by an operation signal from an operating device (not illustrated) provided in the interior of the vehicle 10, as a travel mode to be applied to acceleration/deceleration control of the vehicle 10. Every time the travel mode applied to the vehicle 10 is changed via operation of the operating device, the mode setting unit 31 notifies the changed travel mode to the rate-of-change setting unit 33 and the control unit 34.

When the operating device is operated to apply drive assist mode, the mode setting unit 31 further notifies the rate-of-change setting unit 33 and the control unit 34 that drive assist mode is applied. Similarly, when the operating device is operated to terminate the application of drive assist mode, the mode setting unit 31 notifies the rate-of-change setting unit 33 and the control unit 34 that application of drive assist mode is terminated.

The detection unit 32 detects traffic congestion around the vehicle 10. To achieve this, the detection unit 32 detects another vehicle by inputting an exterior sensor signal representing the surroundings of the vehicle 10 obtained by the vehicle exterior sensor 11 into a classifier that has been trained to detect a vehicle traveling in an area around the vehicle 10. Such a classifier may be one based on a “deep neural network (DNN)” having architecture of a convolutional neural network (CNN) type or an attention mechanism.

Based on the speed of the detected vehicle, the detection unit 32 determines whether traffic around the vehicle 10 is congested. To achieve this, the detection unit 32 tracks the vehicle detected from each of time-series exterior sensor signals obtained in a most recent predetermined period to determine changes in the relative position between the detected vehicle and the vehicle 10, and estimates the speed of the detected vehicle, based on the changes in the relative position and the speed of the vehicle 10.

When the vehicle exterior sensor 11 is a camera configured to take pictures of an area around the vehicle 10 and the exterior sensor signal is an image, the bottom position of a region in the image including the detected vehicle (hereafter an “object region”) is assumed to correspond to the position where the detected vehicle is on the road surface. Further, positions in an image correspond one-to-one to directions viewed from the camera that generates the image. Thus the detection unit 32 can estimate the distance from the camera, which is the vehicle exterior sensor 11, to the detected vehicle and the direction from the vehicle 10 to the detected vehicle, by referring to the bottom position of the object region in the image and parameters of the camera, such as the height of the mounted position, the orientation, and the angle of view.

When the vehicle exterior sensor 11 is a range sensor, the detection unit 32 estimates the distance measured in the direction corresponding to the vehicle detected in the exterior sensor signal as the distance between the vehicle 10 and the detected vehicle.

The detection unit 32 executes the above-described processing on each of time-series exterior sensor signals obtained in the most recent predetermined period to estimate the positions of the detected vehicle relative to the vehicle 10 at the times of generation of the respective exterior sensor signals. In addition, the detection unit 32 determines changes in the position of the detected vehicle relative to the vehicle 10 from the relative positions at the times of generation of the individual exterior sensor signals in the most recent predetermined period arranged in chronological order, and estimates the speed of the detected vehicle relative to the vehicle 10, based on the changes in the relative position.

When multiple vehicles are detected, the detection unit 32 applies a predetermined tracking technique, such as KLT tracking, to track the individual detected vehicles over the time-series exterior sensor signals. For each detected vehicle being tracked, the detection unit 32 estimates the position and speed of the detected vehicle relative to the vehicle 10.

When the average of the estimated speed of the detected vehicle has been less than a predetermined reference speed by more than a congestion determination threshold for at least a predetermined period (e.g., several seconds to ten seconds), the detection unit 32 determines that traffic is congested. The reference speed may be, for example, a speed limit or a legal speed of a road section being traveled by the vehicle 10, or a speed that is set via the operating device provided in the interior of the vehicle 10. The detection unit 32 identifies the road section being traveled by the vehicle 10 and the speed limit or the legal speed of the road section by referring to map information and the current position of the vehicle 10. The map information is prestored in the memory 22. The current position of the vehicle 10 is determined by a receiver of a satellite positioning system mounted on the vehicle 10, such as a GPS receiver.

The detection unit 32 notifies the rate-of-change setting unit 33 of the result of determination whether traffic around the vehicle 10 is congested.

The rate-of-change setting unit 33 sets the upper limit of the rate of change in acceleration/deceleration (hereafter the “upper-limit rate of change”), depending on the set travel mode and whether drive assist mode is applied. In the present embodiment, when the set travel mode is high response mode, the rate-of-change setting unit 33 sets the upper-limit rate of change so that the upper-limit rate of change for the case where drive assist mode is set is less than the upper-limit rate of change for the case where drive assist mode is not applied, i.e., where the driver manually drives. For example, the upper-limit rate of change for the case where drive assist mode is applied and high response mode is set is set 0.6 to 0.8 times the upper-limit rate of change for the case where drive assist mode is not applied and high response mode is set. This reduces the occurrence of sudden acceleration and deceleration in control of travel according to drive assist mode. Thus the driver is prevented from feeling uneasy about travel of the vehicle 10, even when drive assist mode is applied and high response mode is set.

When drive assist mode is applied and high response mode is set, the rate-of-change setting unit 33 may set the upper-limit rate of change for the case where traffic congestion around the vehicle 10 is detected by the detection unit 32 below the upper-limit rate of change for the case where traffic congestion is not detected. This results in the vehicle 10 accelerating and decelerating slowly when the speed of the vehicle 10 is low, and thus prevents the driver from feeling uneasy about travel of the vehicle 10 more reliably.

When the set travel mode is not high response mode, the rate-of-change setting unit 33 sets an upper-limit rate of change depending on the travel mode, i.e., an upper-limit rate of change lower than the upper-limit rate of change for the case where high response mode is set, regardless of whether drive assist mode is applied.

The rate-of-change setting unit 33 notifies the set upper-limit rate of change to the control unit 34.

When drive assist mode is not applied, the control unit 34 refers to a map corresponding to the set travel mode, among maps prepared for the respective travel modes and each representing the relationship between the accelerator position, the number of revolutions of an engine or a motor included in the power train, and target torque. Based on the map referred to, the control unit 34 sets target torque depending on the accelerator position corresponding to the amount of depression of the accelerator pedal by the driver, and generates a control signal of the power train according to the set target torque. However, the control unit 34 generates a control signal so that the rate of change in acceleration/deceleration is less than or equal to the upper-limit rate of change in the set travel mode until the acceleration/deceleration corresponding to the target torque is reached. The control unit 34 then outputs the generated control signal to the power train. Specifically, the control unit 34 controls the power train according to feedback control, such as PID control. In addition, the control unit 34 controls a brake device (not illustrated), depending on the amount of depression of the brake pedal by the driver.

While drive assist mode is applied, the control unit 34 controls the power train so that the vehicle 10 travels at a set target vehicle speed. In addition, the control unit 34 controls the power train to keep at least a predetermined distance between the vehicle 10 and a vehicle traveling ahead of the vehicle 10 on a host vehicle lane being traveled by the vehicle 10. To achieve this, the control unit 34 detects other vehicles traveling in an area around the vehicle 10 by processing similar to that described in relation to the detection unit 32. In addition, the control unit 34 detects lane lines by inputting an image generated by the camera, which is an example of the vehicle exterior sensor 11, into a classifier that has been trained to detect a lane line. The control unit 34 then determines a region in the image sandwiched between two lane lines closest to the vehicle 10 among the detected lane lines as a host vehicle lane region representing the host vehicle lane. Of the detected vehicles, the control unit 34 identifies a vehicle whose object region in the image has a bottom included in the host vehicle lane region and that is closest to the bottom of the image as a vehicle ahead. Alternatively, of the detected vehicles, the control unit 34 may identify a vehicle in a direction corresponding to the travel direction of the vehicle 10 as a vehicle ahead. The control unit 34 estimates the distance to the vehicle ahead by processing similar to that described in relation to the detection unit 32. Alternatively, the control unit 34 may receive the result of detection of other vehicles from the detection unit 32 to identify a vehicle ahead, and further receive the result of estimation of the distance to the identified vehicle ahead from the detection unit 32.

When the estimated distance to the vehicle ahead (in the following also referred to as the “distance between the vehicles”) is less than the predetermined distance, the control unit 34 sets target acceleration/deceleration and a rate of change in acceleration/deceleration so as to decelerate the vehicle 10. Specifically, the control unit 34 sets target acceleration/deceleration according to the set travel mode so that the deceleration is greater as the distance to the vehicle ahead is shorter or the speed of the vehicle 10 relative to the vehicle ahead is greater. When the estimated distance to the vehicle ahead is greater than or equal to the predetermined distance, the control unit 34 sets target acceleration/deceleration according to the set travel mode so that the speed of the vehicle 10 approaches the target vehicle speed. However, when the speed of the vehicle ahead is less than the target vehicle speed, the control unit 34 sets target acceleration/deceleration according to the set travel mode so that the distance between the vehicles is equal to the predetermined distance and that the relative speed between the vehicle 10 and the vehicle ahead is zero. To achieve this, the control unit 34 sets target acceleration/deceleration, based on, for example, a mathematical relation corresponding to the set travel mode among mathematical relations between the distance between vehicles, relative speed, and target acceleration/deceleration that are provided in advance for the respective travel modes. In addition, the control unit 34 sets a rate of change in acceleration/deceleration according to the set travel mode. However, when the set travel mode is high response mode, the control unit 34 sets a rate of change in acceleration/deceleration at or below the upper-limit rate of change set by the rate-of-change setting unit 33. The control unit 34 then determines target torque depending on the set target acceleration/deceleration, and outputs a control signal depending on the target torque and the rate of change in acceleration/deceleration to the power train. In addition, the control unit 34 generates a control signal of the brake device of the vehicle 10 depending on the set target acceleration/deceleration and rate of change in acceleration/deceleration as necessary, e.g., at decelerating the vehicle 10, and outputs the generated control signal to the brake device.

When the driver presses down the accelerator pedal or the brake pedal by more than a predetermined amount, the control unit 34 may control the power train according to the driver's driving operation even if drive assist mode is applied. In this case, when high response mode is set, the control unit 34 applies the upper-limit rate of change for the case where the driver manually drives, as the upper-limit rate of change.

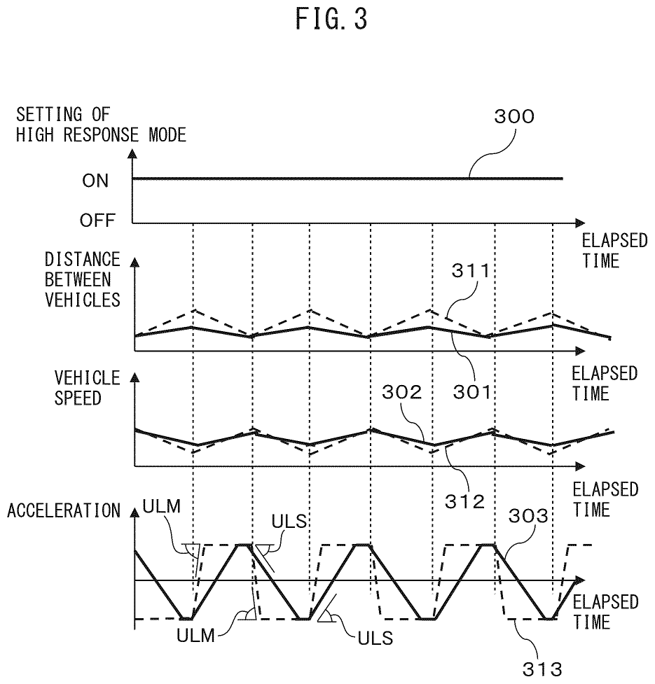

FIG. 3 schematically illustrates acceleration/deceleration control in drive assist mode according to the first embodiment for the case where high response mode is set. The abscissa in FIG. 3 represents elapsed time. In the top chart, a graph 300 represents time-varying changes in the state of setting of high response mode. In the second chart from the top, a graph 301 represents time-varying changes in the distance between the vehicle 10 and a vehicle ahead according to the present embodiment, and a graph 311 represents time-varying changes in the distance between the vehicles for the case where the upper-limit rate of change is set to ULM, which is the value for the case where the driver manually drives, as a comparative example. In the third chart from the top, a graph 302 represents time-varying changes in the speed of the vehicle 10 according to the present embodiment, and a graph 312 represents time-varying changes in the speed of the vehicle 10 for the case where the upper-limit rate of change is set to ULM, which is the value for the case where the driver manually drives, as a comparative example. In the bottom chart, a graph 303 represents time-varying changes in the acceleration/deceleration of the vehicle 10 according to the present embodiment, and a graph 313 represents time-varying changes in the acceleration/deceleration of the vehicle 10 for the case where the upper-limit rate of change is set to ULM, which is the value for the case where the driver manually drives, as a comparative example.

In the present embodiment, when drive assist mode is applied while high response mode is set, the upper-limit rate of change ULS in acceleration/deceleration is set to a value less than the upper-limit rate of change ULM for the case where the driver manually drives. Thus the acceleration/deceleration of the vehicle 10 varies more slowly in the present embodiment than in the comparative example, as indicated by the graphs 303 and 313. As a result, the range of changes in the distance between the vehicle 10 and the vehicle ahead is smaller in the present embodiment than in the comparative example, as indicated by the graphs 301 and 311. Similarly, the range of changes in the speed of the vehicle 10 is smaller in the present embodiment than in the comparative example, as indicated by the graphs 302 and 312. In the present embodiment, the occurrence of sudden acceleration and deceleration is reduced in this way, and thus changes in the speed of the vehicle 10 and changes in the distance between the vehicle 10 and the vehicle ahead are also reduced. This prevents the driver from feel uneasy, even if travel of the vehicle 10 is controlled according to both high response mode and drive assist mode.

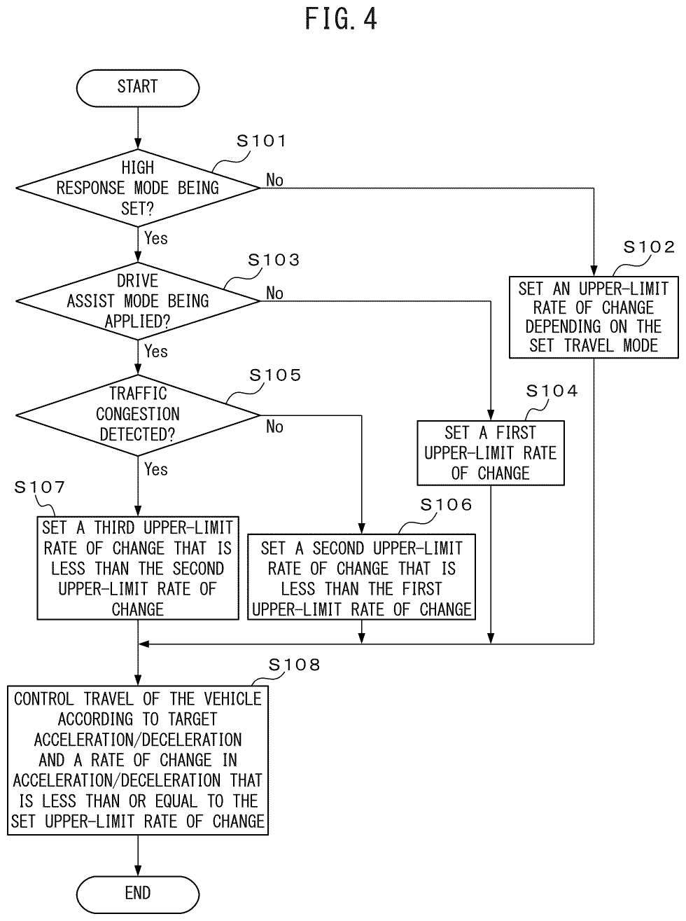

FIG. 4 is an operation flowchart of the vehicle control process according to the first embodiment.

The rate-of-change setting unit 33 determines whether high response mode is set as a travel mode applied to the vehicle 10, by referring to notification from the mode setting unit 31 (step S101). When high response mode is not set (No in step S101), the rate-of-change setting unit 33 sets an upper-limit rate of change depending on the set travel mode (step S102).

When high response mode is set (Yes in step S101), the rate-of-change setting unit 33 determines whether drive assist mode is applied to the vehicle 10, by referring to notification from the mode setting unit 31 (step S103). When drive assist mode is not applied (No in step S103), the rate-of-change setting unit 33 sets a first upper-limit rate of change that is higher than the upper-limit rate of change for the case where another travel mode is set (step S104). When drive assist mode is applied (Yes in step S103), the rate-of-change setting unit 33 determines whether traffic congestion around the vehicle 10 is detected by the detection unit 32 (step S105). When traffic congestion around the vehicle 10 is not detected (No in step S105), the rate-of-change setting unit 33 sets a second upper-limit rate of change that is less than the first upper-limit rate of change (step S106). When traffic congestion around the vehicle 10 is detected (Yes in step S105), the rate-of-change setting unit 33 sets a third upper-limit rate of change that is less than the second upper-limit rate of change (step S107). In some embodiments, the second and third upper-limit rates of change are higher than the upper-limit rate of change for the case where another travel mode is set.

When the upper-limit rate of change is set, the control unit 34 sets target acceleration/deceleration and a rate of change in acceleration/deceleration that is less than or equal to the upper-limit rate of change, depending on the set travel mode and the driver's operation of the accelerator or the distance to a vehicle ahead and a target vehicle speed, and controls travel of the vehicle 10 according to the set target acceleration/deceleration and rate of change in acceleration/deceleration (step S108).

As has been described above, the vehicle controller sets the upper-limit rate of change in acceleration/deceleration for the case where drive assist mode is applied to be less than the upper-limit rate of change for the case where the driver manually drives, when travel of the vehicle is controlled in high response mode. This enables the vehicle controller to reduce the occurrence of sudden acceleration and deceleration in control of travel of the vehicle according to both drive assist mode and high response mode. The vehicle controller can therefore prevent the driver from feeling uneasy in control of travel of the vehicle according to both drive assist mode and high response mode.

According to a modified example, the mode setting unit 31 may stop applying high response mode, when the operating device is operated to apply drive assist mode and drive assist mode begins to be applied to the vehicle 10 while high response mode is set. In this case, the mode setting unit 31 may change the travel mode that is set while drive assist mode is applied from high response mode to normal travel mode or fuel-efficient mode. This further reduces the occurrence of sudden acceleration and deceleration in control of travel of the vehicle 10 when drive assist mode is applied.

According to another modified example, the rate-of-change setting unit 33 may decrease the upper-limit rate of change as the speed of the vehicle 10 measured by a vehicle speed sensor (not illustrated) mounted on the vehicle 10 decreases, when drive assist mode is applied. In this case, the vehicle 10 accelerates and decelerates more slowly as the speed of the vehicle 10 is lower, and thus the driver is less likely to feel uneasy when drive assist mode is applied.

According to still another modified example, the rate-of-change setting unit 33 may set the upper-limit rate of change, based on the set travel mode and whether drive assist mode is applied, regardless of whether traffic congestion around the vehicle 10 is detected. In this case, processing of the detection unit 32 may be omitted. Thus, computational burden of the processor 23 is reduced.

### Second Embodiment

The following describes a second embodiment. In the second embodiment, the vehicle controller notifies the driver that high response mode is set, when drive assist mode is additionally applied while high response mode is set. The following describes the differences from the first embodiment.

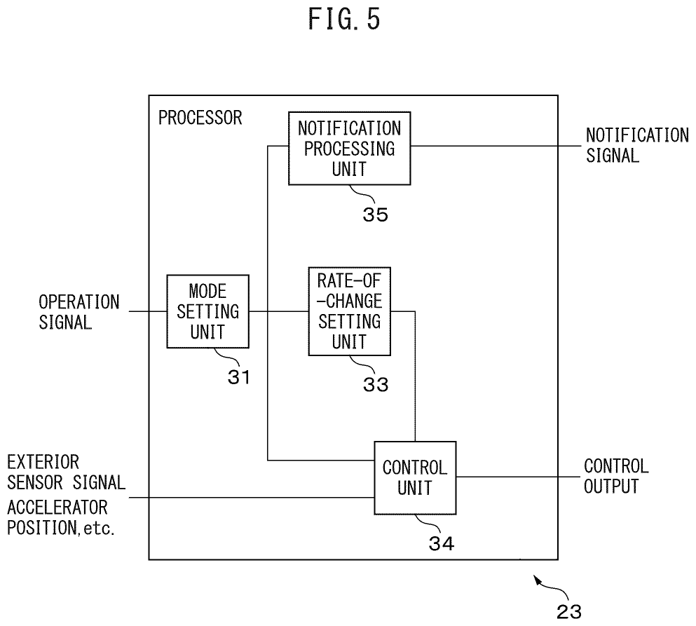

FIG. 5 is a functional block diagram of the processor 23, related to a vehicle control process according to the second embodiment. The processor 23 includes a mode setting unit 31, a rate-of-change setting unit 33, a control unit 34, and a notification processing unit 35. These units included in the processor 23 are, for example, functional modules implemented by a computer program executed by the processor 23, or may be dedicated operating circuits provided in the processor 23.

When an operation signal indicating that operation to apply drive assist mode is performed is received from the operating device while high response mode is set, the mode setting unit 31 notifies the notification processing unit 35 that high response mode is set and that drive assist mode is additionally applied.

When notified by the mode setting unit 31 that drive assist mode is additionally applied while high response mode is set, the notification processing unit 35 generates a notification signal indicating that high response mode is set, and outputs the notification signal to the notification device 12. In this way, the notification processing unit 35 notifies the driver via the notification device 12 that high response mode is set. To this end, the notification processing unit 35 causes the speaker included in the notification device 12 to output a voice meaning that high response mode is set. Alternatively, the notification processing unit 35 causes the display included in the notification device 12 to display a message or an icon meaning that high response mode is set. Alternatively, the notification processing unit 35 lights up or blinks a light source corresponding to high response mode among the light sources included in the notification device 12. The driver is notified of setting of high response mode in this way, and is thus prevented from feeling uneasy even when sudden acceleration and deceleration occur as a result of control of travel of the vehicle 10 in drive assist mode and high response mode.

In the present embodiment, the rate-of-change setting unit 33 may set the same upper-limit rate of change, regardless of whether drive assist mode is applied, even when high response mode is set. The control unit 34 sets target acceleration/deceleration and a rate of change in acceleration/deceleration, depending on the accelerator position or a target vehicle speed and the distance between a vehicle ahead and the vehicle 10, as in the first embodiment. However, in the present embodiment, the control unit 34 sets a rate of change in acceleration/deceleration at or below the upper-limit rate of change depending on the set travel mode, regardless of whether drive assist mode is applied. The control unit 34 outputs a control signal depending on the set target acceleration/deceleration and rate of change in acceleration/deceleration to the power train and, as necessary, to the brake device.

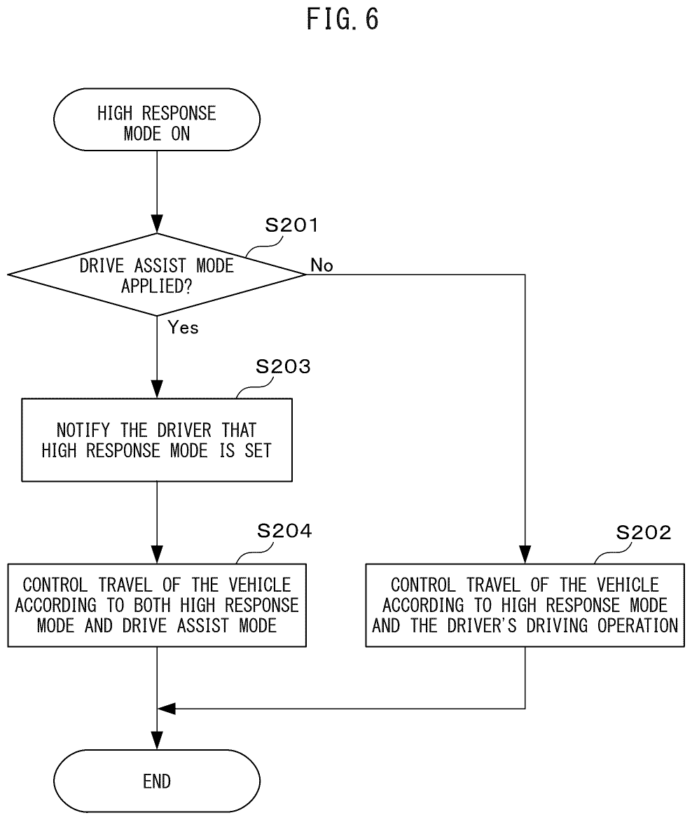

FIG. 6 is an operation flowchart of the vehicle control process according to the second embodiment. While high response mode is on, the processor 23 executes the vehicle control process in accordance with the operation flowchart described below.

The mode setting unit 31 determines whether an operation signal indicating application of drive assist mode is received from the operating device (step S201). When no operation signal indicating application of drive assist mode is received (No in step S201), the control unit 34 controls travel of the vehicle 10 according to high response mode and the driver's driving operation (step S202).

When an operation signal indicating application of drive assist mode is received by the mode setting unit 31 (Yes in step S201), the notification processing unit 35 notifies the driver via the notification device 12 that high response mode is set (step S203). The control unit 34 then controls travel of the vehicle 10 according to both high response mode and drive assist mode (step S204).

As has been described above, the vehicle controller notifies the driver that high response mode is set, when drive assist mode begins to be applied while high response mode is set. The driver is therefore prevented from feeling uneasy even when sudden acceleration and deceleration is caused by control of travel in drive assist mode and high response mode.

According to a modified example, the processor 23 in the second embodiment may also include a detection unit 32, as in the first embodiment. In this case, in some embodiments, the detection unit 32 detects another vehicle traveling ahead of the vehicle 10, based on a portion representing a region ahead of the vehicle 10 in an exterior sensor signal. For example, when the vehicle exterior sensor 11 includes a camera that takes pictures of a region in front of the vehicle 10, the detection unit 32 inputs an image generated by the camera into a classifier, thereby detecting a vehicle traveling ahead of the vehicle 10. The detection unit 32 then detects traffic congestion, based on the vehicle traveling ahead of the vehicle 10, as in the first embodiment. In this way, the detection unit 32 can detect traffic congestion ahead of the vehicle 10 before the vehicle 10 reaches the rear end of the traffic congestion. When traffic congestion is detected, the detection unit 32 notifies the detection to the notification processing unit 35. When notified by the mode setting unit 31 that drive assist mode is applied while high response mode is set and notified by the detection unit 32 that traffic congestion is detected, the notification processing unit 35 notifies the driver via the notification device 12 that high response mode is set, before the vehicle 10 starts decelerating in drive assist mode. This prevents the driver from feeling uneasy, even if the vehicle 10 suddenly decelerates by control of travel in drive assist mode and high response mode when the vehicle 10 reaches the rear end of the traffic congestion.

The processor 23 may execute both the vehicle control process according to the first embodiment or its modified example and the vehicle control process according to the second embodiment or its modified example. In other words, the processor 23 may execute processing of the mode setting unit 31, the detection unit 32, the rate-of-change setting unit 33, the control unit 34, and the notification processing unit 35. More specifically, when drive assist mode is applied while high response mode is set, the processor 23 may notify the driver via the notification device 12 that high response mode is set, and set the upper-limit rate of change in acceleration/deceleration to a value less than the upper-limit rate of change for the case where the driver manually drives. In this case, the processor 23 may decrease the upper-limit rate of change with the speed of the vehicle 10, or further decreases the upper-limit rate of change when traffic around the vehicle 10 is congested. When drive assist mode is applied while high response mode is set, the processor 23 may notify the driver via the notification device 12 of a suggestion about a change to normal travel mode or fuel-efficient mode as well as the fact that high response mode is applied. When an operation signal indicating that operation to approve of the suggestion is performed is received from the operating device, the processor 23 may change the set travel mode to normal travel mode or fuel-efficient mode.

The computer program for achieving the functions of the processor 23 of the ECU 13 according to the above-described embodiments or modified examples may be provided in a form recorded on a computer-readable portable storage medium, such as a semiconductor memory, a magnetic medium, or an optical medium.

What is claimed is:

1. A vehicle controller comprising:
a processor configured to:
set an upper limit of a rate of change in acceleration for a case where drive assist mode in which travel of a host vehicle is controlled depending on a distance between a vehicle ahead and the host vehicle is applied to be less than the upper limit for a case where a driver of the host vehicle manually drives, when travel of the host vehicle is controlled in high response mode in which responsiveness to acceleration is higher than in normal travel mode, and
control travel of the host vehicle so that the rate of change in acceleration is less than or equal to the set upper limit.

2. The vehicle controller according to claim 1, wherein the processor is further configured to stop applying the high response mode while the drive assist mode is applied.

3. The vehicle controller according to claim 1, wherein the processor is further configured to detect traffic congestion around the host vehicle, wherein
when the traffic congestion is detected, the processor makes the upper limit less than when the traffic congestion is not detected.

4. The vehicle controller according to claim 1, wherein the processor decreases the upper limit as a speed of the host vehicle decreases.

5. A vehicle controller comprising
a processor configured to:
notify a driver of a host vehicle, via a notification device provided in the host vehicle, that high response mode in which responsiveness to acceleration is higher than in normal travel mode is set, when drive assist mode in which travel of the host vehicle is controlled depending on a distance between a vehicle ahead and the host vehicle is additionally applied while travel of the host vehicle is controlled in the high response mode.

6. The vehicle controller according to claim 5, wherein the processor is further configured to detect traffic congestion around the host vehicle, wherein
the processor gives notification that the high response mode is set, before the host vehicle starts decelerating after the traffic congestion is detected.

7. A method for vehicle control, comprising:
setting an upper limit of a rate of change in acceleration for a case where drive assist mode in which travel of a host vehicle is controlled depending on a distance between a vehicle ahead and the host vehicle is applied to be less than the upper limit for a case where a driver of the host vehicle manually drives, when travel of the host vehicle is controlled in high response mode in which responsiveness to acceleration is higher than in normal travel mode; and
controlling travel of the host vehicle so that the rate of change in acceleration is less than or equal to the set upper limit.

8. A non-transitory recording medium that stores a computer program for vehicle control, the computer program causing a processor mounted on a host vehicle to execute a process comprising:
setting an upper limit of a rate of change in acceleration for a case where drive assist mode in which travel of the host vehicle is controlled depending on a distance between a vehicle ahead and the host vehicle is applied to be less than the upper limit for a case where a driver of the host vehicle manually drives, when travel of the host vehicle is controlled in high response mode in which responsiveness to acceleration is higher than in normal travel mode; and
controlling travel of the host vehicle so that the rate of change in acceleration is less than or equal to the set upper limit.
